(19) United States
(12) Patent Application Publication
(10) Pub. No.: US 2004/0234410 A1
(43) Pub. Date: Nov. 25, 2004

(54) Nickel alloy composition

(75) Inventors: Mark H. Shipton, Bristol (GB); Robert W. Broomfield, Bristol (GB)

Correspondence Address: OLIFF & BERRIDGE, PLC, P.O. BOX 19928, ALEXANDRIA, VA, 22320, US

(73) Assignee: ROLLS-ROYCE PLC, London (GB)

(21) Appl. No.: 10/779,664

(22) Filed: Feb. 18, 2004

Related U.S. Application Data
(63) Continuation of application No. 09/987,683, filed on Nov. 15, 2001, now abandoned.

(30) Foreign Application Priority Data
Nov. 18, 2000 (GB) 0028215.2

(51) Int. Cl. C22C 19/05; B32B 15/01

(52) U.S. Cl. 420/443

(57) ABSTRACT

A nickel alloy composition, having particular utility for forming an oxidation resistant blade tip on a turbine blade, preferably has a composition substantially as defined by the nominal composition Cr 4.5 wt %; Al 6 wt %; Co 4 wt %; Ta 6 wt %; Re 4 wt %; Hf 0.15 wt %; C 0.05 wt %; Si 0.1 wt %; B 0.005 wt %; W 2 wt %; La 0.003-0.005 wt %; and Y 0 0.003 to 0.005 wt %; the remainder being nickel

### FIELD OF THE INVENTION

The present invention relates to a nickel alloy composition. In particular, the invention relates to a nickel alloy composition for application to the tips of gas turbine blades to act as an oxidation and corrosion resistant barrier.

### BACKGROUND OF THE INVENTION

U.S. Pat. No. 5,622,638 (Schell et al; 22 Apr. 1997), the disclosure of which is incorporated herein by reference, describes a nickel-based alloy composition for application to the tips of gas turbine blades (which are conventionally formed from a nickel-based superalloy) to act as an oxidation and corrosion resistant barrier, most particularly a high temperature oxidation and corrosion resistant barrier. The nickel-based alloy composition consists essentially of about 14 to about 18 wt % Cr, about 6.45 to about 6.95 wt % Al, about 9.75 to about 11.45 wt % Co, about 5.95 to about 6.55 wt % Ta, about 1.85 to about 2.35 wt % Re, about 0.05 to about 1.75 wt % Hf, about 0.006 to about 0.03 wt % Zr, about 0.02 to about 0.11 wt % C, up. to about 1.1 wt % Si, and up to about 0.01 wt % B, with the balance being nickel and typical impurities. In one embodiment, illustrated in FIGS. 8 to 10 of the prior art, the alloy can be deposited by a known laser deposition process to provide a so-called squealer (38), being a wall extending from the blade tip (12) and enclosing a tip well. The bottom of the tip well is defined by the surface of the blade tip (12).

It is an object of the present invention to provide an improved or at least alternative nickel-based alloy composition, suitable for application to the tips of gas turbine blades to act as an oxidation and corrosion resistant barrier.

### SUMMARY OF THE INVENTION

According to a first aspect of the present 10 invention, there is provided a nickel alloy composition comprising about 4 to about 8 (e.g. about 4.5 to about 6.5) wt % Cr, about 5 to about 6.5 (e.g. about 5.5 to about 6.2) wt % Al, about 2 to about 6 (e.g. about 3 to about 4) wt % Co, about 4 to about 8 (e.g. about 5 to about 7) wt % Ta, about 3 to about 5 (e.g. about 3.5 to about 4.5) wt % Re, about 0.1 to about 0.5 (e.g. about 0.1 to about 0.2) wt % Hf, about 0.04 to about 0.1 (e.g. about 0.04 to about 0.06) wt % C, about 0.05 to about 0.3 (e.g. about 0.05 to about 0.15) wt % Si, and about 0.003 to about 0.01 (e.g. about 0.003 to about 0.007) wt % B, with at least the major part (e.g. at least about 85%, more particularly at least about 90%) of the balance being nickel.

The nickel alloy composition of the present invention preferably substantially excludes at least one (most preferably all) of Mo, Ti and. V, and still more preferably excludes all of Mo, Ti, V and Nb. These elements are found generally to harm the resistance of the alloy to high temperature oxidation and corrosion.

It is preferred that the nickel alloy composition of the present invention further includes one or more additional element selected from up to about 5 (e.g. about 1 to about 3) wt % W, up to about 5 (e.g. up to about 1) wt % Pt, up to about 0.008 (e.g. about 0.003 to about 0.008, more particularly:about 0.003 to about 0.005) wt % La, and up to about 0.008 (e.g. about 0.003 to about 0.008, more particularly about 0.003 to about 0.005) wt % Y.

Still more preferably, the nickel alloy composition consists essentially of Cr, Al, Co, Ta, Re, Hf, C, Si, B and most preferably also one or more of W, Pt, La and Y, in the amounts stated above, the balance being nickel. Of the optional elements W, Pt, La and Y, it is most preferred that La and Y should be present, suitably in approximately equal amounts. The expression “consists essentially of” is to be understood as allowing for the presence of typical impurities, in addition to the stated elements.

In one embodiment of the present invention, the nickel alloy composition has the nominal composition Cr (4.5 wt %), Al (6 wt %), Co (4 wt %), Ta (6 wt %), Re (4 wt %), Hf (0.15 wt %), C (0.05 wt %), Si (0.1 wt %), B (0.005 wt %), W (2 wt %), La (0.003-0.005 wt %), and Y (0.003-0.005 wt %), the remainder being nickel. Nickel alloy compositions substantially corresponding to the “nominal composition” set out above are also included within that definition.

The nickel alloy composition of the present invention preferably comprises about 50% gamma prime 30 volume fraction at room temperature and a gamma prime solvus of between about 1265 and about 1280 deg. C. In alloys where Ti is excluded, the gamma prime regions will consist of Ni₃(Al,Ta).

The nickel alloy composition of the present invention preferably has, at elevated temperatures above about 800 deg. C, at least half the creep and the tensile and low cycle fatigue (LCF) strengths of conventional nickel-based superalloys (e.g. CMSX-4) from which gas turbine blades are typically cast, without substantially sacrificing oxidation and corrosion resistance, and more particularly high temperature oxidation and corrosion resistance.

Cyclic oxidation tests carried out on samples of the nickel alloy composition of the present invention at 1200 deg. C show that the preferred alloy composition has excellent high temperature oxidation resistance, and in particular a broad front oxidation rate approximately 20% of the oxidation rate of CMSX-4.

The nickel alloy composition of the present invention may be provided in any suitable physical form for application to the tip of the gas turbine blade. As discussed below, it may be convenient in certain circumstances for the alloy composition to be provided in, for example, a physical form selected from powders, foils, rods and wires. Powders for use in a laser welding process may conveniently have a particle size range of +45/−140 um.

According to a second aspect of the present invention, there is provided the use of the nickel alloy composition of the present invention, for forming a blade tip of a gas turbine blade, particularly a blade tip of a gas turbine propulsion engine, to act as an oxidation and corrosion resistant barrier and optionally to provide the tip with rub tolerance.

According to a third aspect of the present invention, there is provided a method for forming a blade tip of a gas turbine blade, particularly a blade tip of a gas turbine propulsion engine, the method comprising applying the nickel alloy composition of the first aspect of the present invention to the tip (i.e. the radially outermost portion) of the gas turbine blade.

The formed blade tip may comprise a blade tip structure such as, for example, a squealer. The nickel alloy composition may be initially applied to a depth in excess of the desired alloy depth of the final formed blade tip or blade tip structure, and the applied nickel alloy composition subsequently machined to reduce the depth thereof to form the desired blade tip or blade tip structure.

In the method, the step of applying the alloy composition to the tip of the gas turbine blade may preferably be accomplished by fusing the alloy composition onto the blade tip, preferably under controlled conditions whereby the desired configuration of the blade tip is achieved after cooling of the fused mass of the alloy composition. The step of applying the alloy composition to the tip of the blade is preferably carried out by means of a laser cladding process or by weld deposition process.

In the laser cladding process, the nickel alloy composition is provided initially in the form of a powder and is applied (e.g. as a layer) to the tip of the gas turbine blade by fusing the powder alloy to the tip of the gas turbine blade. A laser beam is directed at the selected superalloy surface of the gas turbine blade, and the finely divided nickel alloy powder according to the first aspect of the present invention is fed directly into the laser beam impingement zone. The energy density of the laser beam is sufficient to melt the nickel alloy powder, causing the powder particles to fuse to the superalloy surface of the gas turbine blade and to each other, thereby forming a homogeneous layer of relatively high density. Effectively, the particles of the nickel alloy powder are sintered to the blade surface to provide the required barrier layer. For further details of the laser cladding process, which may be used to apply the nickel alloy composition to a wide range of metal components in addition to gas turbine blades, please refer to U.S. Pat. Nos. 4,804,815 and 5,160,822, the disclosures of which are incorporated herein by reference.

The laser cladding process is particularly shape-faithful, making available shaping accuracies of ±0.04 mm in the laying down of the alloy of the present invention.; Where the configuration of the final form is critical, laser cladding may be preferred for this reason, as it can lead to savings of time and money in subsequent machining and other post-processing stages.

In the weld deposition process, the nickel alloy composition is initially provided in any convenient physical form, for example in rod or wire form, and is applied to the tip of the gas turbine blade by feeding the alloy composition into a plume or arc of a welding torch and onto the surface of the blade tip. In this process, the nickel alloy composition is fused to the blade surface to provide the required barrier layer.

The deposited nickel alloy layer provides a high integrity treatment for the tips of turbine blades, e.g. shroudless turbine blades, in a gas turbine, and in particular in a gas turbine propulsion engine.

The method for forming a blade tip, according to the present invention, may alternatively comprise a repair method for repairing damage to a metal article such as a cast metal turbine component, more particularly a turbine blade, a turbine shroud segment or a nozzle guide vane.

According to a fourth aspect of the present invention, there is provided a method for repairing a metal article such as, for example, a cast metal turbine component (e.g. a turbine blade, a turbine shroud segment or a nozzle guide vane), the method comprising applying the nickel alloy composition of the first aspect of the invention to a damaged portion of the metal article to repair the same. Essentially the same processes as described herein with reference to the formation of blade tips or blade tip structures on gas turbine blades may be used in the method for repairing a metal article such as, for example, a cast metal turbine component. Instead of forming a blade tip or blade tip structure, with optional machining of the unfinished tip or structure to the final desired configuration, however, in the repair method the alloy composition of the present invention will be applied to the metal article to form initially a repair structure, which is typically subsequently machined to arrive at the final desired repaired configuration.

### BRIEF DESCRIPTION OF THE DRAWINGS

The present invention will now be described in greater detail, but without limitation, with reference to the accompanying drawings, in which:

FIG. 1 shows in perspective view a turbine blade of a gas turbine propulsion engine, provided with a squealer tip formed from an alloy of the present invention;

FIG. 2 shows an enlarged perspective view of the tip portion of the blade of FIG. 1, immediately after initial laying down of the unfinished form of the squealer wall, indicating also the path followed by the laser cladding apparatus during that initial laying down process;

FIG. 3 shows the blade of FIG. 1 in a laser cladding apparatus during the initial laying down of the alloy of the present invention for formation of the blade tip; and

FIG. 4 shows a vertical cross-sectional view through the tip wall of the blade of FIG. 1, after machining to form the finished squealer wall profile.

### DETAILED DESCRIPTION OF THE DRAWINGS

Referring to the drawings, in which like parts are designated alike, a turbine blade 1 of a gas turbine propulsion engine has a geometry which is generally conventional in the art. The blade 1 has a root 2 and a tip 3, the tip 3 being provided with a squealer comprising a peripheral wall 4. The squealer serves in operation to enclose a body of relatively cool air at the tip of the blade in the tip well bounded by the wall 4. Holes (not shown) in the tip of the blade provide for air flow communication between hollow chambers within the blade and the said body of relatively cool air.

The blade is preferably formed from a suitable high temperature material, such as an appropriate nickel-based superalloy of a type known in the art, and may be cast as single crystal or directionally solidified casting to promote the high temperature properties of the blade 1.

The wall 4 of the squealer tip is formed using the novel nickel alloy composition of the first aspect of the invention. A representative composition of the alloy composition is substantially as follows: Cr (4.5 wt %), Al (6 wt %), Co (4 wt %), Ta (6 wt %), Re (4 wt %), Hf (0.15 wt %), C (0.05 wt %), Si (0.1 wt %), B (0.005 wt %), W (2 wt %), La (0.003-0.005 wt %), and Y (0.003-0.005 wt %), the remainder eing nickel.

For carrying out the process and use of the present invention, the alloy composition is first formed by a conventional alloying process, as will be well within the abilities of one of ordinary skill in the art. The alloy composition is suitably initially prepared as an ingot, from with any desired physical form for the blade tip formation can be formed by conventional methods.

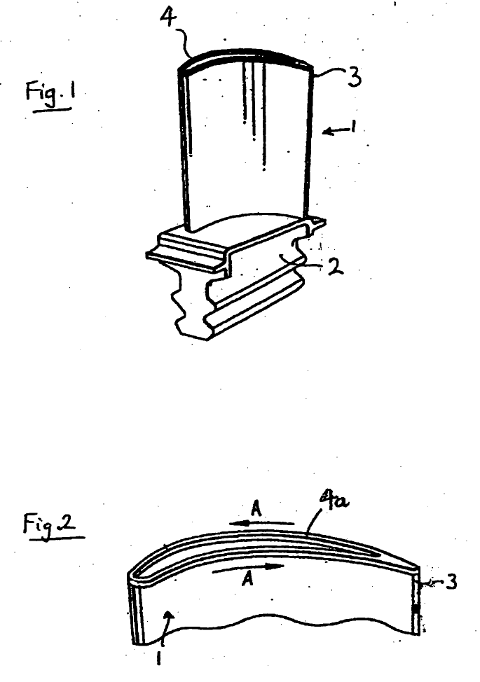

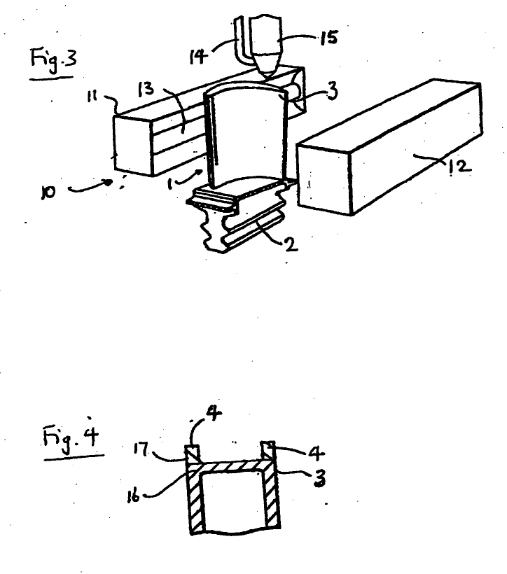

In the illustrated process for forming the blade tip 3 of the gas turbine blade. 1, a laser cladding process is employed for the initial laying down of the alloy composition, as illustrated more particularly in FIGS. 2 and 3 of the drawings.

Referring to FIG. 3, the tip 3 of the blade 1 is arranged under a conventional laser cladding apparatus 10, such as, for example, a Sulzer Metco laser welding apparatus available from Sulzer Metco Holding AG (Wohlen, Switzerland; web: www.sulzermetco.com; tel: +41 56 618 8181). The apparatus includes lateral pre-heat boxes 11,12, each of which includes a quartz heating lamp 13, and an alloy powder feed line 14 extending from the powder feed system (not shown) to the laser beam tube 15. The laser beam tube 15 directs a laser beam to the blade tip 3. The alloy powder (suitably having a particle size range +45/−140 um) enters the laser beam in close proximity to the surface of the blade 1 as it moves relative to the beam, to cause the powder to melt in the laser beam and fuse to the blade surface.

The laser beam may be produced by any suitable laser source, such as a carbon dioxide laser with a power output of between about 1 and about 5 kilowatts. Conventional means for focussing the laser beam are provided in the apparatus.

In essence, the laser cladding process involves irradiating a portion of the blade surface with the laser beam, so that a relatively small molten pool of the superalloy of the blade surface is formed. The powdered alloy of the present invention is fed into the pool and dispersed therein at a rate of between about 0.1 and about 0.4 grams per second through a nozzle 16 of the apparatus via a stream of an inert gas such as argon. The powder particles fuse into the molten pool, which is then caused to solidify when the laser beam is moved away. The solidification of the molten pool if preferably effected rapidly, to minimise the formation of gamma prime phases in the alloy.

FIG. 2 shows by arrows A the peripheral deposition line followed in the laser cladding process, by which an unfinished wall 4a of the deposited alloy composition of the present invention, typically about 0.2 mm thicker than the intended ultimate height of the intended finished wall 4, is initially laid down on the blade tip 3. In one example, the initial deposition may conventiently lay down an unfinished wall 4a of height about 0.7 mm.

After the initial deposition, the unfinished wall 4a is machined back to the desired height (e.g. about 0.5 mm) and configuration, using a conventional abrasion process. The cross-sectional profile of the resultant squealer is shown in FIG. 4, in which numeral 16 represents the material of the blade and numeral 17 represents the deposited material of the novel alloy composition of the present invention.

It is found that the use of a laser cladding process for the laying down of the alloy composition of the present invention leads to a particularly shape-faithful deposition of the unfinished wall of the squealer.

### Industrial Applicability

The alloy, process and use of the present invention enables gas turbine blade tips to be formed with acceptable strength (particularly tensile and low cycle fatigue (LCF) strength), creep and high temperature oxidation and corrosion resistance properties, from an alloy composition which is cheaper than conventional alloys and can be deposited faster and more efficiently than conventional alloys, particularly when a laser cladding or weld deposition process is used.

More particularly, the alloy composition of the present invention makes available, in gas turbine blade tip structures, strengths exceeding half the strength of the nickel-based single crystal superalloys from which the turbine blade itself is cast, substantially greater than the strengths conventionally achievable through the use of thermal sprayed and machined MCrAlY overlay coatings for the blade tips, together with the processing advantages mentioned above.

Moreover, the same alloy can serve as a repair medium, in methods for repairing damage to a range of metal articles, particularly cast metal turbine components such as turbine blades, turbine shroud segments or nozzle guide vanes.

What is claimed is:

1. A nickel alloy composition comprising about 4 to about 8 wt % Cr, about 5 to about 6.5 wt % Al, about 2 to about 6 wt % Co, about 4 to about 8 wt % Ta, about 3 to about 5 wt % Re, about 0.1 to about 0.5 wt % Hf, about 0.04 to about 0.1 wt % C, about 0.05 to about 0.3 wt % Si, and about 0.003 to about 0.01 wt % B, with at least the major part of the balance being nickel.

2. A nickel alloy composition as claimed in claim 1, substantially excluding at least one of Mo, Ti and V.

3. A nickel alloy composition as claimed in claim 1, substantially excluding all of Mo, Ti, V and Nb.

4. A nickel alloy composition as claimed in claim 1, further including one or more element selected from up to about 5 wt % W, up to about 5 wt % Pt, about 0.003 to about 0.008 wt % La, and about 0.003 to about 0.008 wt % Y.

5. A nickel alloy composition as claimed in claim 1, wherein the composition consists essentially of Cr, Al, Co, Ta, Re, Hf, C, Si, B and optionally one or more element selected from up to about 5 wt % W. up to about 5 wt % Pt, about 0.003 to about 0.008 wt % La, and about 0.003 to about 0.008 wt % Y, the balance being nickel.

6. A nickel alloy composition, substantially as defined by the nominal composition: Cr 4.5 wt %; Al 6 wt %; Co 4 wt %; Ta 6 wt %; Re 4 wt %; Hf 0.15 wt %; C 0.05 wt %; Si 0.1 wt %; B 0.005 wt %; W 2 wt %; La 0.003-0.005 wt %; and Y 0.003-0.005 wt %; the remainder being nickel.

7. A method for forming a blade tip of a gas turbine blade, particularly a blade tip of a gas turbine propulsion engine, the method comprising applying a nickel alloy composition, comprising about 4 to about 8 wt % Cr, about 5 to about 6.5 wt % Al, about 2 to about 6 wt % Co, about 4 to about 8 wt % Ta, about 3 to about 5 wt % Re, about 0.1 to about 0.5 wt % Hf, about 0.04 to about 0.1 wt % C, about 0.05 to about 0.3 wt % Si, and about 0.003 to about 0.01 wt % B, with at least the major part of the balance being nickel, to the tip of the gas turbine blade.

8. A method for repairing a metal article, the method comprising applying a nickel alloy composition, comprising about 4 to about 8 wt % Cr, about 5 to about 6.5 wt % Al, about 2 to about 6 wt % Co, about 4 to about 8 wt % Ta, about 3 to about 5 wt % Re, about 0.1 to about 0.5 wt % Hf, about 0.04 to about 0.1 wt % C, about 0.05 to about 0.3 wt % Si, and about 0.003 to about 0.01 wt % B, with at least the major part of the balance being nickel, to a damaged portion of the metal article to repair the same.

9. A method as claimed in claim 8, wherein the metal article is a cast metal turbine component.

10. A method as claimed in claim 9, wherein the cast metal turbine component is a turbine blade, a turbine shroud segment or a nozzle guide vane.

11. A method as claimed in claim 7, wherein the application of the nickel alloy composition is carried out by a laser cladding or weld deposition process.

12. A method for forming a blade tip or blade tip structure of a gas turbine blade, or for forming a repair structure to repair a cast metal turbine component, the method comprising laser cladding or weld depositing a nickel alloy composition, comprising about 4 to about 8 wt % Cr, about 5 to about 6.5 wt % Al, about 2 to about 6 wt% Co, about 4 to about 8 wt % Ta, about 3 to about 5 wt % Re, about 0.1 to about 0.5 wt % Hf, about 0.04 to about 0.1 wt % C, about 0.05 to about 0.3 wt % Si, and about 0.003 to about 0.01 wt % B, with at least the major part of the balance being nickel, to the tip of the gas turbine blade or to the cast metal turbine component, to a depth in excess of the desired blade tip or structure, and subsequently machining the nickel alloy composition to reduce the depth thereof to form the desired blade tip or structure.

13. A method as claimed in claim 12, wherein the nickel alloy composition is applied by laser cladding.

14. A method as claimed in claim 12, wherein the blade tip comprises a squealer.

15. A nickel alloy composition as claimed in claim 4, substantially excluding at least one of Mo, Ti and V.

16. A nickel alloy composition as claimed in claim 4, substantially excluding all of Mo, Ti, V and Nb.

17. A nickel alloy composition as claimed in claim 5, substantially excluding at least one of Mo, Ti and V.

18. A nickel alloy composition as claimed in claim 5, substantially excluding all of Mo, Ti, V and Nb.

19. A method as claimed in claim 8, wherein the application of the nickel alloy composition is carried out by a laser cladding or a weld deposition process.

20. A method as claimed in claim 13, wherein the blade tip comprises a squealer.

21. A nickel alloy composition comprising about 4 to about 8 wt % Cr, about 5 to about 6.5 wt % Al, about 2 to about 6 wt % Co, about 4 to about 8 wt % Ta, about 3 to about 5 wt% Re, about 0.1 to about 0.5 wt % Hf, about 0.04 to about 0.1 wt % C, about 0.05 to about 0.3 wt % Si and about 0.003 to about 0.01 wt % B, about 0.003 to about 0.008 wt % La and about 0.003 to about 0.008 wt % Y, with at least the major part of the balance being nickel.
